(19) United States
(12) Patent Application Publication
(10) Pub. No.: US 2004/0057977 A1
(43) Pub. Date: Mar. 25, 2004

(54) Water-based pest bait compositions having water-sensitive insecticides and methods of making and use thereof

(75) Inventors: James P. Gardner JR., Stillwater, MN (US); S. John Barcay, Burnsville, MN (US); Emory H. Matts, St. Paul, MN (US); Steven J. Lange, St. Paul, MN (US); Thomas R. Mohs, Eagan, MN (US); Robert D. Hei, Baldwin, WI (US)

Correspondence Address: MERCHANT & GOULD PC, P.O. BOX 2903, MINNEAPOLIS, MN, 55402-0903, US

(73) Assignee: Ecolab Inc.

(21) Appl. No.: 10/661,912

(22) Filed: Sep. 12, 2003

Related U.S. Application Data
(63) Continuation-in-part of application No. 10/115,459, filed on Apr. 2, 2002.
Application No. 10/115,459 is a division of application No. 09/404,985, filed on Sep. 22, 1999, now abandoned.

(51) Int. Cl. A01N 25/08

(52) U.S. Cl. 424/410

(57) ABSTRACT

Compositions, methods-of-preparing, and methods-of-use of a water-based rapid acting insecticidal bait containing a stabilized water-sensitive insecticide as an active ingredient are described. Also described is a storage stable composition containing the water-sensitive insecticide and an insecticide stabilizer, such as boric acid or a nanoparticle. The composition can be easily applied into cracks, crevices, voids, or other pest harborage areas to rapidly kill insect pests, particularly cockroaches.

### CROSS-REFERENCE TO RELATED APPLICATIONS

This application is a continuation-in-part application to copending U.S. patent application Ser. No. 10/115,459, filed Apr. 2, 2002, which is a divisional of application Ser. No. 09/404,985, filed Sep. 22, 1999, now abandoned. This application is also related to U.S. patent application Ser. No. 09/870,098, filed May 30, 2001, which issued as U.S. Pat. No. 6,564,502 on May 20, 2003, which is a divisional of application Ser. No. 09/404,985, filed Sep. 22, 1999, now abandoned.

### BACKGROUND OF THE INVENTION

This invention relates to a water-based, fast-acting pest bait containing a water-sensitive insecticide as the active ingredient for controlling insects, particularly cockroaches.

Historically, toxic baits for controlling crawling insects such as cockroaches have been water-based. With cockroaches especially, water is presumed necessary for good bait performance. Unfortunately, water-based bait products rapidly lose effectiveness due to water loss, rancidity, degradation of active ingredients, and other factors. Studies of water-based paste baits have confirmed that water loss, repellent properties of active ingredients, and insecticide resistance are the most important factors affecting bait performance. Appel, A. G., J. Econ Entomol. 85 (4):1176-1183 (1992), Robinson, W. H., Proceedings of the National Conference on Urban Entomology, 77-91 (1992), and Rust, N. K., “Managing Household Pests”, in Advances in Urban Pest Management, G. W. Bennett and M. Owens (eds), Van Norstrand Reinhold, N.Y. 335-368 (1986).

One approach to improve on water-based insecticide products has been to use a dust or a paste composition that includes a so-called water powder with the insecticide. This water powder is water encapsulated with hydrogenated soybean oil. Such a product is described in U.S. Pat. No. 5,820,855 to Barcay et al.

In another approach, water-free, fat-based pest baits are described in U.S. Pat. Nos. 5,914,105 and 5,464,613. These compositions are paste forms and include as a major ingredient a fat-based carrier. Although paste products do not drift, they are difficult to apply and require an applicator to apply pastes in cracks and crevices or voids. Another disadvantage of water-free, fat-based paste products are that they are not as fast acting as water-based products, especially against cockroaches.

In still other approaches, nanoparticles have been used as carriers or delivery vehicles of active ingredients for agriculture formulations to provide benefits, such as improved bio-availability, improved bio-adhesion, or improved dispersion, see for example U.S. Pat. Nos. 5,904,936, 5,874,029, 6,133,199, and 6,428,814.

Acephate is a very desirable insecticide, particularly in killing cockroaches. Acephate's desirability is based on the fact that there is no known insecticide resistance, it has a very low mammalian toxicity, and it has an extremely fast kill rate on cockroaches. However, acephate is not stable in water-based matrices over time. Although acephate has been described in the above water-free, fat-based patents, these types of baits are generally not as palatable and therefore are not as effective as water based baits.

A disadvantage of using a water-sensitive insecticide, such as acephate, is that such compounds rapidly decompose when formulated in most bait matrices both under storage and use conditions. Thus, field personnel mix the active insecticide ingredient with the bait matrix shortly prior to use as described, for example, in U.S. Pat. No. 6,564,502.

One approach to stabilizing and inhibiting decomposition of a water-sensitive insecticide, such as acephate, is described in U.S. Pat. No. 5,698,540, where one or more N-alkyl-2-pyrrolidone compounds is mixed with acephate bulk or acephate containing liquid pesticidal composition. However, this patent is directed to aqueous solutions and does not concern a bait or the attractancy of the insecticidal composition.

Thus, there remains a need for improved stability, rapid acting, water-based baits that utilize water-sensitive insecticides.

### SUMMARY OF THE INVENTION

We have found in the present invention a method that allows a water-sensitive insecticide, for example, acephate, to be used successfully in a water-based matrix without the need for on-site mixing. Additionally or alternatively, the invention includes a composition which, if desired, can be prepared at the site of application and applied, for example, to cracks, crevices, or voids. In embodiments, the composition can be formulated and stored for extended periods well before use and thereafter applied. The composition is active when formulated and, when applied, results in rapid kill of insect pests, particularly cockroaches. A preferred rapid acting composition is in the form of a gel. Another preferred rapid acting composition is in the form of a powder or a paste. Still another preferred rapid acting composition is in the form of a pourable liquid.

We have also found that formulations with such water-sensitive insecticides, such as acephate, may be formulated by the manufacturer and stored with a reasonable amount of shelf-life and are shippable to the site of use without having to mix the active with the bait matrix at the site. In addition, the inventive formulations also prolong the efficacy of the active ingredient once it is applied in the field, particularly in humid and hot environments, where the efficacy of an insecticide such as acephate would otherwise be short-lived. We have found that addition of an insecticide stabilizer, for example boric acid, to the bait matrix substantially reduces the decomposition of the water sensitive insecticide acephate, such that acephate can be mixed with the bait matrix by the manufacturer eliminating the need to mix the insecticide at the use site.

Accordingly, in embodiments the invention provides a process for preparing a ready-to-use insecticidal bait composition including the steps of (a) dissolving a water sensitive insecticide in a specified amount of water, (b) combining the resulting mixture of insecticide and water with an effective amount of an insecticide stabilizer, such as boric acid or a nanoparticle component, (c) combining the resulting mixture with a bait base containing a feeding stimulant, an attractrant, or both, and optionally containing one or more gelling agent(s), (d) agitating the resulting combination until thoroughly mixed, and, if desired, (e) allowing the mixed combination to form a gel or paste.

In embodiments the invention also provides an insecticidal bait composition comprising:

(a) an insecticidal effective amount of a water-sensitive insecticide;

(b) an effective amount of an insecticide stabilizer; and

(c) a base bait containing water, and at least one of a feeding stimulant and an attractant.

In embodiments the invention also provides an insecticidal bait composition comprising: about 0.10 to about 2 wt-% acephate insecticide; about 5 to about 50 wt-% boric acid insecticide stabilizer; about 10 to about 30 wt-% water; and the balance being a bait base.

In embodiments the invention also provides a method of prolonging the insecticidal activity of a water soluble, water degradable insecticide in a bait composition containing the insecticide comprising combining the bait composition with from about 5 to about 60 wt-% of boric acid based on the total weight of the combined composition.

In embodiments the invention also provides a process for stabilizing a water-sensitive insecticide contained in an insecticidal bait composition comprising:

(a) dissolving a water-sensitive insecticide in a specified amount of water;

(b) mixing an effective amount of an insecticide stabilizer with a bait base containing at least one of a feeding stimulant and an attractrant;

(c) combining the resulting insecticide and water mixture with the resulting stabilizer and bait base mixture; and

(d) optionally agitating the resulting combination.

In embodiments the invention also provides a process for stabilizing a water-sensitive insecticide contained in an insecticidal bait composition comprising:

(a) dissolving a water sensitive insecticide in a specified amount of water;

(b) combining the resulting mixture of insecticide and water with an effective amount of an insecticide stabilizer;

(c) combining the resulting mixture of insecticide, water, and stabilizer with a bait base containing at least one of a feeding stimulant and an attractrant, and optionally containing one or more gelling agent(s);

(d) optionally agitating the resulting combination; and

(e) optionally allowing the mixed combination to form a gel or paste.

In embodiments the invention also provides an insecticidal bait composition prepared by the process comprising: combining:

(a) an insecticidal effective amount of a water-sensitive insecticide;

(b) an effective amount of an insecticide stabilizer; and

(c) a base bait containing water, and at least one of a feeding stimulant and an attractant.

In still other embodiments the invention provides a kit for application of an insecticidal bait composition comprising:

(a) a water-sensitive insecticide in admixture with a borate compound, a nanoparticle component, or mixtures thereof; and a base bait; and

(b) a dispenser for dispensing the insecticidal bait.

In embodiments the invention also provides an insecticidal bait composition including about 0.1 to about 5 wt-% of a water soluble, water degradable insecticide such as, for example, acephate; about 5 to about 60 wt-% of boric acid; about 3 to about 40 wt-% of water, and the balance being a bait base.

In embodiments of the present invention the insecticide can be, for example, acephate at about 1.5 wt-%; the boric acid can be, for example, from about 15 to about 50 wt-%, water can be present, for example, in about 10 to about 30 wt-%, and the remainder of the composition can be the bait base.

In embodiments of the present invention there is provided a method of prolonging the insecticidal activity of a water-soluble, water-degradable insecticide, such as acephate, comprising adding to a composition having about 0.1 to about 5 wt-% of the insecticide, about 5 to about 60 wt-% of boric acid.

In embodiments, the method of prolonging the insecticidal activity of the water-soluble, water-degradable insecticide insecticidal bait can include, for example, adding a nanoparticle component to the composition, alone or in combination with boric acid.

In embodiments of the present invention there is also provided a method of controlling insect pests, particularly cockroaches, comprising applying to target areas, that is areas to be controlled, an effective insecticidal amount of the above compositions and as illustrated herein.

### BRIEF DESCRIPTION OF THE DRAWING

FIG. 1 is a chart comparing the mean knockdown time on applying an acephate gel versus a fipronil gel for cockroaches.

FIG. 2 is a chart showing acephate decomposition without boric acid and with varying amounts of boric acid.

FIG. 3 is a chart comparing stability data of a standard acephate bait formulation to the same formulation having a boric acid insecticide stabilizer present.

### DETAILED DESCRIPTION OF THE INVENTION

A water-based insecticidal bait composition according to the invention includes a water-sensitive insecticide, an insecticide stabilizer, water, and a bait base. The water-based insecticidal bait composition can be referred to more simply as the bait composition. The bait composition can be prepared in the form of a gel. In addition, the bait composition can be prepared and packaged well in advance for subsequent use, or it can be prepared at the site of application. The bait composition of the present invention has the advantages of being rapidly acting against insect pests, particularly cockroaches, and can be applied easily to cracks, crevices, voids, or other insect harborage areas.

The compositions of the present invention can include optional performance additives, such as an agglomeration agent, a suspending agent, and like agents. The compositions of the present invention provide insecticidal baits having stabilized insecticidal effectiveness over time, including in-storage or in-use formulation stability, insecticidal activity, and in-use insect attractancy.

Water-Sensitive Insecticide

A water-sensitive insecticide is an insecticide that degrades in the presence of water and loses its insecticidal activity. Water-sensitive insecticides are generally water-soluble. Exemplary water-sensitive insecticides include acephate and methamidophos. Acephate is a rapid-acting insecticide. Acephate is a broad-spectrum insecticide used for control of wide range of sucking and chewing insect pests such as aphids, thrips, loopers, cutworms, armyworms, bugs, hoppers, whiteflies, fireworms, cockroaches, and like pests. Acephate and related phosphate ester type insecticides can kill insects by, for example, direct contact or ingestion. Acephate is a fine crystalline powder that is highly water-soluble (700 mg/mL). It is a desirable active ingredient because there is no known insecticide resistance and it has very low mammalian toxicity. Acephate has a molecular formula of C₄H₁₀NO₃PS and is chemically known as O,S-dimethyl acetylphosphoramidothioate. Typically, acephate and other water-sensitive insecticides can be used in the composition at a minimum content of about 0.1 wt-% in order to maintain some insecticidal activity. In embodiments, an insecticidal effective amount of insecticide can be characterized by the insecticidal bait composition containing a water-sensitive insecticide, for example acephate, having an insecticidal potency KT50 of less than about 24 hours after exposure. Other insecticidal bait compositions having other water-sensitive insecticides will be readily apparent to one of ordinary skill in the art upon comprehending the present invention and as illustrated herein. A preferred range of water-sensitive insecticide is in an amount of, for example, from about 0.1 to about 5 wt-%. A more preferred amount of water-sensitive insecticide, such as acephate for example, in a gel composition is from about 1 to about 2 wt-%. An even more preferred amount of water-sensitive insecticide is from about 1 wt-% based on the total weight of the bait composition. Other water-sensitive insecticides include, for example, methamidophos, chemically known as O,S-dimethyl phosphoramidothioate, which is the deacetyl analog of acephate.

The stability of the water sensitive insecticide, such as acephate, can depend on many factors, and can further depend upon the details of the factors and any interactions thereof, such as, the compound, the immediate surrounding and conditions, such as soil, water, in vivo, in vitro, temperature, pressure, pH, the presence or absence of complexing groups such as chelates or ligands, metal ions, proteins, and like factors, and which factors can accelerate or retard degradation of the insecticide.

Acephate has an average soil half-life of 3 days or less; a forest-leaves half-life of 2 days; and a plants half-life of 2 days. Acephate has a hydrolysis half-life at pH 5 to 7 of, for example, 50 days at 21° C. and 20 days at 40° C.; and 16 days at pH 9 and 21° C. Thus, acephate is more stable in acidic conditions and least stable in alkaline conditions. Hydrolysis products of acephate include O,S-dimethyl phosphorothioate (DMPT), and S-methyl acetyl phosphoramidothiate (RE 17,245). Methamidophos, a known metabolic breakdown product of acephate, has an average soil half-life of 2 to 6 days. (See Chevron Chemical Co.—Ortho division, 1972b. Hydrolysis of Orthene. CDPR Volume Number: 108-163. #54145.) “Half-life” of insecticides is understood to be the time required for half of the compound to degrade or transform into another compound(s), e.g. in the environment, or be eliminated, e.g. from a body. Thus, generally after one half-life there is 50% degradation or elimination and the concentration of the compound is 50% of its original concentration; after 5 half-lives there is 97% degradation or elimination and the concentration 3%.

Boric acid is a known insecticide, see for example, Professional Pest Control Products, of Pensacola, Fla., <www.pestproducts.com> which mentions several boric acid or borate containing insecticide products. Also, the abovementioned U.S. Pat. No. 6,564,502, discloses rapid acting bait compositions containing a water-sensitive insecticide such as acephate which may include up to about 50 wt-% of the total base bait of borax or boric acid which can be used to lengthen the insecticidal activity of the baits, see for example, col. 3, lines 60-63. The borax or boric acid was believed to lengthen the insecticidal activity of the baits by providing a second insecticide which was substantially water insensitive.

Unlike many insecticides, boric acid has little or no repellency to insects, and consequently, roaches repeatedly return to properly treated areas until they die. Although boric acid has a lower toxicity compared to phosphate ester type insecticides, both can kill insects by direct contact or ingestion.

Boric acid based insecticidal baits are generally effective only after multiple feedings by cockroaches that enable the cockroaches to ingest a lethal dose. Although not wanting to be limited by theory, it is believed that boric acid kills cockroaches primarily by disrupting the peritrophic membrane in the gut of the cockroach, which interferes with food-energy conversion. Consequently, boric acid takes longer than most insecticides to kill cockroaches, roughly one week. The lethal time 50 (LT50) for boric acid bait is about 5 to 8 days and can depend upon the bait and test method used. See Appel, A. G., J. Econ Entomol., 83, 153-159 (1990), “Performance of Baits Against German Cockroaches.”

Boric acid is very stable chemically, has no odor, and will remain active as a dust as long as it remains dry. However, boric acid in bait can cross-link forming a hard crust which can reduce bait palatability (see Ware, G. “Chemicals Used to Control Invertebrates.” The Pesticide Book, 4^{th} edition, Thompson Pubs, Fresno Calif. 1994, p. 72). Boric acid is typically ingested by cockroaches, although absorption of cuticle wax also occurs with boric acid dust (Ibid. p 72). In terms of mammalian toxicity, boric acid can be inhaled, ingested, or absorbed through broken skin; all of which require a relatively large amount to have detrimental effects. The acute oral LD₅₀ for rats is 3.16 grams per kilogram body mass and the acute dermal LD₅₀ for rabbits is greater than 2 grams per kilogram body mass. Also, boric acid may cause slight eye and lung irritation (see Borid MSDS, http://www.wil-kil.com/technical/2002labels/M3004.pdf). In contrast, acephate containing baits require only a single feeding to kill cockroaches. Acephate spray was first introduced in 1972, has a strong odor, and can stain surfaces such as carpet (see Braness, G., “Insecticides,” Mallis Handbook of Pest Control, 8th Edition, Mallis Handbook and Technical Training Company, 1997, p. 1070). Acephate kills by binding to cholinesterase enzymes, preventing the enzymes from modulating neural activity, causing hyper-excitation of the nerves, followed by death. Consequently, acephate kills cockroaches relatively quickly upon ingestion of bait or contact with treated surfaces, usually within about two hours. It is known in the art that acephate can even kill cockroaches on contact. However, acephate is not chemically stable as it hydrolyzes in water in pH dependant reactions resulting in an active by-product methamidophos. Acephate has a relatively low mammalian toxicity. Still other suitable water-sensitive insecticides for use in the present invention will be readily apparent to one of ordinary skill in the art. (See for example “Compendium of Pesticide Common Names”, for insecticides listing and chemical name listing, <www.hclrss.demon.co.uk/class_pesticides.html>).

Insecticide Stabilizer

The insecticide stabilizer can be any component that lengthens the storage stability and insecticidal activity of a water-based insecticidal bait composition that includes a water-sensitive insecticide. The insecticide stabilizer can be, for example, a chemical compound or particulate material. The stabilizer can beneficially interact or react with components of the bait or preferably the insecticide to provide an insecticide stabilized against degradation without substantially encumbering the insecticidal effectiveness, activity, or properties of the insecticide. Exemplary insecticide stabilizers include boric acid; borate compounds, such as boric acid esters which can hydrolyze to boric acid and the corresponding alcohol(s) such as linear alcohols, branched alcohols, glycols, glycol ethers, and like hydroxy compounds; borate salts including hydrates and solvates such as borax; nanoparticles; and combinations or mixtures thereof.

In general, insecticidal effectiveness, insecticidal activity, insecticidal efficacy, or like terms, can be characterized as the concentration of active insecticide which kills about 50% of a representative sample of insects within about 24 hours of exposure, for example, by contact or ingestion. The bait composition preferably includes a sufficient amount, such as of at least 0.05 wt-% and preferably at least 0.1 wt-%, of the insecticide-stabilizer, to provide the bait composition with stabilize insecticidal activity. In embodiments, an effective amount of an insecticide stabilizer can be from about 5 to about 60 wt-% of the total weight of the insecticidal bait composition. The palatability of the food matrix must also be maintained so that the bait composition is ingested by the insects in adequate quantities to reach a lethal concentration. It is generally desirable to provide a sufficient amount of the insecticide stabilizer in the bait composition to provide a desired lengthening of the insecticidal activity of the bait composition compared with a bait composition not containing the insecticide stabilizer. It is additionally desirable to minimize the amount of the insecticide stabilizer in order to provide room in the bait composition for the insecticide and the bait base. In embodiments the bait composition can include from about 5 wt-% to about 60 wt-% of the insecticide stabilizer. In embodiments of the present invention, the bait base includes as part of the solid mixture from about 5 to about 60 wt-% of boric acid as the insecticide-stabilizer based on the total weight of the insecticidal bait composition. In embodiments of the present invention, the ratio of water-sensitive insecticide to insecticide-stabilizer, for example, acephate:boric acid or acephate:nanoparticle component, can be for example, from about 1:5 to about 1:50. The relative weight percentage of insecticide to insecticide-stabilizer in embodiments can be, for example, from about 1 to about 2 wt-% acephate to from about 5 to about 50 wt-% boric acid, more preferably from about 1 to about 2 wt-% acephate to from about 10 to about 30 wt-% boric acid, still more preferably from about 1 to about 2 wt-% acephate to from about 15 to about 20 wt-% boric acid, and most preferably from about 1 wt-% acephate to about 15-20 wt-% boric acid insecticide-stabilizer based, for example, on the total weight of the bait composition. Although not desired to be limited by theory, the most preferable boric acid ratio and range with respect to acephate appeared to be the result of an optimal balance between high stability of the water-sensitive acephate insecticide in the formulation and a high acceptance or attractancy levels for cockroaches. Thus, for example, when boric acid was at about 5 to about 10 wt-% the bait was more readily accepted by cockroaches but the acephate was less stable, that is shorter lived and less potent with time. Conversely, when boric acid was at 30-50 wt-% boric acid, the bait is less readily accepted by cockroaches, that is less attractive and less likely to be consumed, but the acephate is more stable, that is longer-lived and more likely to be lethal with time.

We have now discovered that the addition to the bait base composition of boric acid or like insecticidal stabilizer compounds can provide storage-stabilization, use-stabilization, and extended effectiveness to the water-sensitive insecticide, such as acephate. Accordingly, the insecticidal bait can now be pre-mixed with the active water-sensitive insecticide well in advance of use. The resulting insecticidal bait composition can have a stable shelf-life for up to, for example, about one year. Stable shelf-life means that the bait composition retains insect attractancy properties and insecticidal properties following a period of storage, such as warehousing, transport, marketing display, and like non-use situations. Additionally, including the insecticidal stabilizer, such as boric acid or a nanoparticle component, in the insecticidal composition the insecticidal activity of the dispersed product or the in-use product is also prolonged. This is particularly the result when the product is used in hot and humid environments. Since the insecticide stabilizer can provide apparent stabilization to water-sensitive insecticide in the baits, in-storage, in-use, or both, formulators or applicators should take appropriate prudent precautions in preparing, handling, or applying the insecticidal baits of the invention. In embodiments, the insecticide stabilizer lengthens the insecticidal effectiveness of the insecticide by, for example, at least about 10 percent compared to the insecticidal bait composition free of the insecticide stabilizer. In embodiments, the insecticide stabilizer can lengthen the insecticidal effectiveness of the insecticide by, for example, from about 10 to about 50 percent, more preferably from about 50 to about 100 percent, still more preferably from about 100 to about 500 percent, and most preferably from about 500 to about 1,000 percent, compared to the same or identical insecticidal bait composition which is free of the insecticide stabilizer.

Nanoparticles

The term “nanoparticle” generally refers to primary particulate bodies whose longest dimension is from about 1 nanometer up to about 1,000 nm (1 micrometer), and can include bodies that are not solid particulates, such as liquid or gel nanoparticles which retain there primary nanoparticle properties. The primary nanoparticles, because of their small size, may frequently form or exist in associations or clusters with other primary nanoparticles or other formulation ingredients. The associated nanoparticles can have larger apparent particle sizes. Preferably, individual nanoparticles have a high surface area, for example, from about 10 to about 1,500 square meters per gram, and preferably from about 100 to about 1,200 square meters per gram, as determined by, for example, BET methods. Preferably, individual nanoparticles have pores or surface topography or irregularities, which can increase the apparent surface area of the nanoparticles. The high surface area and pores permit the insecticide-water solution to coat and penetrate the outer surface of the nanoparticle component and greatly increase the carrying capacity and stability enhancing effects of the nanoparticle upon the insecticidal properties of the bait composition.

The term “nanoparticle component” can refer to the singular “nanoparticle” or plural “nanoparticles” and can embody one or more nanoparticle ingredients in the composition, for example, one nanoparticle type or a mixture of two or more nanoparticle types.

Nanoparticles suitable for use in the present invention can include, but are not limited to, one or more of the following including mixtures thereof: alkali and alkaline earth oxides, hydroxides, halides or sulfides, such as CaO, MgO, Mg(OH)₂, MgCl₂, and Ca(OH)₂; transition metal oxide, hydroxides or sulfides, such as TiO₂, Fe₂O₃, and MnO₄; inorganic nitrides, such as BN, Al₂N₃; oxides, hydroxides, or sulfides of silicon, aluminum, or boron; inorganic nitrides, sulfides, oxide, or hydroxides of phosphorous, silicon, or aluminum; and clays, for example, inorganic or organic clays, available for example, from Southern Clay Products.

The nanoparticle component can be a combination or mixtures of two or more nanoparticle materials, such as a physical mixture or a composite of MgO, Fe₂O₃, and Mg(OH)₂. The nanoparticle component can have or contain additional species on the surface or within the nanoparticles, for example, oxides, halides, hydroxides, sulfides, nitrides, carbides, phosphates, borides, organic functional groups, for example, Fe(O)(OH), MgO(OH), and mixtures thereof.

The surface of the nanoparticle can also be coated with or impregnated with inorganic materials, organic materials, or second nanoparticles, such as those described above, individually or in mixtures, for example, oxides or salts of Na, K, Ag, or Fe, such as Fe₂O₃ coated on the surface of or impregnated within MgO, TiO₂ coated on the surface of MnO₄, BN impregnated within or coated on the surface of MgO, or halides sorbed or coated on the surface of MgO, and like combinations and modifications.

The nanoparticles may also be impregnated or doped with other elements, or their oxides or hydroxides, and salts thereof, for example, to alter the acidity or basicity of the nanoparticle, for example, doped with atoms, ions, or compounds of Na, K, Fe, V, Al, and like elements. Additionally or alternatively, the hydrophobicity of the nanoparticle can be modified with, for example, a wetting agent or surface modifying agent such as a hydrophilic surfactant, a hydrophobic surfactant, or like agents. The wetting agent or surface modifying agent can be, for example, coated or covalently attached to the nanoparticle.

The nanoparticles of the nanoparticle component can be, for example, in solid, powder, liquid suspension, emulsion, foam, gel, or like forms. These nanoparticles can be formulated as a coating or can be in combination with a coating formulation and which coatings can have antibacterial, biocidal, virucidal, bacteriostatic, mildew-cidal, fungicidal, or having like biocidal or biostatic properties, which can for example, reduce, limit, or control the presence of pathogens, molds, fungi, allergens, or the like in the formulation during storage or use.

In embodiments, preferred nanoparticles are hydroxides and oxides of Mg, Ca, Si, Ti, Zr, Fe, V, Mn, Ni, Cu, Al, or Zn. More preferably, the nanoparticles are hydroxides and oxides of Mg, Ca, Si, Ti, Al, or Zn. Even more preferably, the nanoparticles are hydroxides and oxides of Mg, Ca, Si, Ti, Al, or Zn. An even more preferred nanoparticle component is titanium oxide.

The nanoparticles can be obtained commercially from a variety of sources or can prepared by any method used to prepare nanometer-sized particles, including but not limited to, for example, chemical vapor deposition, laser vaporization, template synthesis (e.g. dendritic materials), precipitation, seed-shell methods, sol-gel methods, aerogel methods, xerogel methods, and like methodologies. Nanoparticles of the present invention can be, for example, nano-sized particles of naturally occurring or synthetic materials, such as clays or zeolites. In embodiments, the nanoparticles preferably can have an average primary particle size of from about 1 nanometer to about 1,000 nanometers, preferably an average primary particle size of up to about 250 to about 500 nanometers, more preferably an average primary particle size of up to about 80 nanometers, even more preferably an average primary particle size up to about 20 nanometers, and most preferably an average primary particle size of from 1 to about 10 nanometers. Although not desired to be limited by theory it is believed that the smaller particle size preferences provide greater particle surface area, greater insecticide loading and carrying capacity, and greater formulation compatibility and stability within the bait-base. Nanoparticles of the present invention can provide additional formulation or use advantages as exemplified in the following illustrations. The nanoparticles may stabilize the water-sensitive insecticide ingredient against hydrolysis. The nanoparticle formulations can be easier to ingest by the feeding insect and are not readily detected by the feeding insect. Consequently, there is no apparent anti-feedant effects associated with the nanoparticle formulations. The nanoparticle formulations are easier to formulate and thereby provide a greater range of formulation options, for example, solids or liquids for traps, liquids or dispersions for sprays, gels, and like applications. The nanoparticle formulations avoid issues encountered with the manufacture or use of conventional formulations such as spray nozzle clogging problems, formulation separation or low dispersibility problems, and like problems. The nanoparticle formulations, alone or in combination with other formulation ingredients, can impart improved aesthetic properties to the formulations, for example, color-free, odor-free, and like properties, and which properties may be desirable where the formulations are formulated, applied, or observed by humans, or where formulations without such properties may have reduced insect kill results, that is for example, an anti-feedant effect.

Bait Base

The bait base can include any components that are generally recognized to be, or act as, insect feeding stimulants, insect attractants, or both. In theory, feeding stimulants are believed to attract insects to a bait composition to entice the insects to eat the bait composition. Feeding stimulants can include carbohydrates, proteins, lipids, and mixtures thereof. Exemplary carbohydrates include maltodextrins, and the like; carbohydrate complexes, corn syrup solids, sugars such as sucrose, glucose, fructose, sorbitol, starches such as corn, potato, and the like. Exemplary proteins include yeast extracts and milk solids, e.g. whole milk powder, and the like.

The feeding stimulants may include, if desired, a gelling agent serving a dual function such as, for example, starches. Exemplary starches include, for example, modified cornstarch. Other gelling agents which may be used as part of the bait base include, for example, gums, e.g. xanthan gum; agars; agaroses; carageenans; bentonite; alginates; collagens; gelatin; polyacrylates; celluloses, or modified cellulose compounds, such as alkylated celluloses; alkylene glycol oligomers, polyethylene glycols, and ethers or esters thereof; polyethylene oxides; polyvinyl alcohols; dextrans; polyacrylamides; polysaccharides, and like compounds, mixtures thereof, or any other common gelling agent or viscosity enhancing agent. A preferred gelling agent in embodiments is, for example, xanthan gum.

In addition to feeding stimulants and gelling agents, the bait base may also contain additional attractants or co-attractants. Examples of attractants are odorants and flavorants such as cyclotenes and the like, plant extracts such as fenugreek and the like, alcohols such as ethanol, or a volatile ester in combination with ethanol. The volatile ester can be made from, for example, a combination of a C₁-C₆ branched or unbranched alcohol with a C₁-C₃ carboxylic acid. Lower alcohols useful in the manufacture of the volatile ester co-attractants of the invention can include, for example, methyl alcohol, ethyl alcohol, n-propyl alcohol, isopropyl alcohol, n-butyl alcohol, isobutyl alcohol, tertiary butyl alcohol, n-amyl alcohol, isoamyl alcohol, tertiary amyl alcohol, n-hexyl alcohol, and mixtures thereof. Carboxylic acids useful in manufacturing the ester attractant of the invention can include, for example, acetic acid, propionic acid, butyric acid, mixtures thereof, and like acids. The associated reactive analogs of the respective carboxylic acids can be used, for example, the acid chloride or acid anhydride. A preferred volatile ester can include, for example, a lower alcohol acetate ester such as n-amyl acetate, isoamyl acetate, isobutyl acetate, n-propyl acetate, ethyl acetate or mixtures thereof. As with gelling agents and feeding stimulants, some of the ingredients may overlap in functional category as they can be both attractants and feeding stimulants, for example, the proteins mentioned above, odorants, and flavorants.

The feeding stimulants, attractants, and optionally gelling agents, are the components of the bait base which comprise the balance of the composition depending on the amount of insecticide, insecticide stabilizer, and water employed to arrive at the composition. While the bait base containing feeding stimulants, optional gelling agents and other attractants, contains the balance of the composition, the amount of gelling agent, when used in this bait base may vary from about 0.1 to 5 wt-% of the total solid mixture. A preferred amount of gelling agent is about 1 wt-% of the solid bait base mixture. In embodiments, the base bait can have insect attractancy characterized by a base bait which retains insect attractancy while the composition retains insecticidal effectiveness, as described and illustrated herein.

Water

The bait composition can include water to provide, for example, the bait composition with a desired texture, feedant properties, attractancy, formulation convenience, and like considerations. In general, the amount of water in the bait composition can be from about 3 to about 50 wt-%. In the case of a bait composition containing from about 1 to about 2 wt-% acephate, the amount of water can be, for example, from about 10 to about 30 wt-%. In embodiments, about 30 wt-% of water is used in a composition containing 1.0 wt-% acephate based on the total weight of the bait composition.

Methods of Preparation

The insect pest bait composition is designed to be prepared, if desired, at the site of use and may employ a kit that forms part of the present invention. An exemplary process description follows.

1. The active water-sensitive insecticide ingredient is contained and stored in its technical form (95.0%-100% pure) in a glass or otherwise impermeable container prior to use. The water-sensitive insecticide is preferably contained in the form of a pellet or powder and the container preferably has a removable-resealable cover and is preferably a glass vial or glass- or poly-lined drum.

2. A mixture of the active water-sensitive insecticide and water prepared by combining the active water-sensitive insecticide ingredient of 1. above with a specified amount of water diluent. The mixture of water and active is thoroughly agitated.

3. The combined mixture of 2 above is then further combined, as soon as practicable, with a previously prepare bait base which is a mixture of feeding stimulants, insecticidal stabilizer such as boric acid or a nanoparticle component, optional gelling agent and, if desired, other attractants. This combined bait base and active mixtures are thoroughly agitated and optionally allowed to gel.

The bait base is preferably contained in a packet, e.g., a re-sealable plastic bag. When the water-sensitive insecticide solution is added, the plastic bag is resealed and the contents mixed preferably by thoroughly kneading the materials. The mixed material can be poured into a disperser, for example, a syringe or dispensing cartridge, or alternatively left in the original mixing packet, until ready for use. This composition yields longer insecticidal life upon field application.

An additional method of preparation of the present invention can include conventional manufacture of a ready-to-use pesticide product. Typically this involves pre-mixing the bait base ingredients with boric acid followed by the addition of the active water-sensitive insecticide ingredient, typically acephate dissolved in water and optionally, for example, sorbed with nanoparticles. This composition is a pre-mixed composition capable of being stored prior to shipping to the user.

Since in this embodiment the composition is pre-mixed, it may be in the form of a gel as above described or, if desired, in paste, granular, or powder form.

As a paste, the above composition can be used as containerized or non-containerized baits, the application depending on the targeted pest. As an example, paste formulations may be applied in cracks or crevices of apartments, homes or industrial settings where pests, especially cockroaches and ants, are likely to reside. Pastes can be applied into cracks and crevices, for example, in the kitchens and bathrooms of the above structures for effective control and killing of these pests. The pastes can be manufactured by well-known methods that include, for example, blending the active insecticide into the bait base and water as defined above. Additional ingredients, if desired, can be added during the blending operation.

An alternative method for preparing a pest bait of the invention relates to the preparation of a granular or powder form. The insecticide composition of the invention can be made by combining the boric acid, water-sensitive insecticide, feeding stimulants and water followed by blending thoroughly. Once blended, the mixture can be dried if required and then transferred to a roller, compactor/granulator with a mesh screen for the desired particle size. Optionally, resulting granular compositions can be transferred to a ribbon type mixture where other ingredients, such as additional liquid feeding attractants can be added. Preferred final granule sizes can be, for example, from about 0.2 to about 5 mm. Alternatively granules may be crushed into a fine powder for preparation of insecticidal dust.

In embodiments which include nanoparticles, the water-sensitive insecticide active ingredient can be sorbed onto or into the nanoparticle component directly from a liquid or gaseous medium. The active ingredient to be sorbed by the nanoparticle component can be a liquid or a gas, or can be converted to either of these phases by, for example, applying heat or cold to the active ingredient. The active ingredient can be sorbed by the nanoparticle component from a solution, semi-suspension, or suspension, for example, by dissolving or suspending the water-sensitive active ingredient in a suitable solvent such as water, aqueous organic solutions, or like carrier liquid. The active ingredient to be sorbed onto or into the nanoparticle component can be present in a carrier gas including but not limited to, for example, air, steam, nitrogen, or carbon dioxide. Further, the active ingredient can be taken-up and combined with the nanoparticle component, for example, in a super-critical fluid, such as super-critical carbon dioxide.

Illustrative materials suitable for sorbing onto or into the nanoparticles, as an active ingredient or as optional additive can include the following: pesticides, including but not limited to pyretheroids, fipronil, hydramethylnon, abamectin, or imadcloprid; organophosphates such as acephate, dichlorvos, diazinon, or chlopyrifos; insect growth regulators such as hexaflumuron, hydroprene, methylprene, or pyriproxyfen; insect repellants, including but not limited to DEET, R-874, MOK 326, and like synthetic repellants, and naturally occurring repellants, such as pyretherins, d-limonene, bifenthrin, ginger compounds, pepper compounds, garlic compounds, and like natural repellant compounds; insect pheromones, pest pheromones, and combinations thereof, including but not limited to heptyl butyrate, muscalure, and like compounds; insecticide synergists, including but not limited to piperonyl butoxide, MGK 264, and like compounds; carboxylic acids, such as benzoic acid, acetic acid, octanoic acid, and like organic acid compounds; quaternary ammonium compounds, for example, dimethyl dialkyl ammonium compounds, such as dimethyl ditallow ammonium compounds, and lower molecular weight tetraalkyl ammonium salt, such as tetra-butyl ammonium chloride; fragrances; dyes; pigments; or mixtures thereof.

The foregoing materials can be combined with the nanoparticle component individually, or in various combinations thereof, for example, as mixtures or solutions. Additionally, other materials or ingredients can be sorbed onto or into the surface of the nanoparticle component, or simply mixed with the nanoparticle component, to provide beneficial compositional, formulational, or performance advantages, such as insect baits, pest baits, foodstuffs, viscosity modifiers, and like additives, including but not limited to: food or food ingredients, such as liquefied or powder milk, cheese, sugar, and like products; materials that can enable or enhance the sensing or detection by the insect or pest of the pest bait, for example, pheromones; and binders, polymers, gels, gums, and like additives, which additives can provide or promote, for example, agglomeration, suspension, wetting, adhesion, and like modifications, of the active material(s), additive(s), and the nanoparticle component.

The nanoparticle component having coated, sorbed, or imbibed materials can be in the form of, for example, a powder, gel, paste, or slurry; which can optionally be pressed or otherwise formed into a specific form or shape, such as a granule or compressed form, for handling or formulation convenience. The nanoparticle component having coated, sorbed, or imbibed active ingredient or other additives, can be further combined with, impregnated onto or into, or otherwise adhered to, other materials, such as clays or foodstuffs and as illustrated herein. The nanoparticle component having coated, sorbed, or imbibed active ingredient or other additives, can be used or sold “as-is” as a product or in a product, or further combined with a system to deliver a desired beneficial result. For example, a nanoparticle component containing sorbed fragrance or odorant may be used as a slow-release or sustained-release product to gradually release the fragrance or odorant into the air for attracting insects or for freshening a room, or it may be part of a system that, for example, plugs into an electrical wall outlet and uses heat or light to release or enhance the release of an insect attractant. Similarly, the nanoparticle component containing a sorbed pesticide can be, for example, used as a slow- or timed-release product to controllably release the pesticide into the environment so as to increase the durational efficacy of the pesticide effect.

It will be readily understood by one of ordinary skill in the art that the treated nanoparticles of the present invention can be used in a variety of ways to disperse, deliver, administer, or otherwise present the composition and active ingredient(s) to potential pest targets, for example, formulation within a solid or liquid foodstuff or baits, evaporation of the active ingredient(s) from the composition, volatilization or aerosolization of the composition as a powder or droplets, and like methods.

Methods of Use

Once the composition is formed, it can be applied directly onto or into cracks and crevices for the control of insect pests, particularly cockroaches. Alternatively, the composition can be deployed and the insecticide presented, for example, in baited traps, in liquid sprays or aerosols, or in vapor or gaseous form, such as by evaporation or candling.

Application of the composition is useful for food and feed handling establishments, such as restaurants; dairies; packaging, bottling and canning plants; bakeries; and mills or anywhere food or feed is stored, prepared, processed, or packaged.

The composition is also useful for spot, crack and crevice treatments in food areas. These include, for example, where food or feed is received, stored, prepared, served, packaged, handled in an enclosed system and where edible waste is stored. The bait composition may be directly applied into cracks and crevices, where equipment meets floors and walls; equipment and counter legs; bases, motors and conduits; holes and openings leading to wall voids where may insects hide.

The composition of the present invention can also be used in non-food areas of feed or food handling establishments including, for example, garbage rooms, restrooms, laboratories, offices, locker rooms, boiler and equipment rooms, garages, mop closets, storage, and like areas. The composition can also be applied to cracks and crevices around baseboards, around water and drain pipes, underneath and behind sinks, lockers, tables, and similar areas where insects may hide.

Finally, the composition can be employed in serving areas of food service establishments including, for example, dining rooms, mess halls and other areas where prepared food is served. The composition can be applied, for example, in pea-sized chunks or smaller placements onto selected surfaces such as baseboards, underneath booths and into cracks and crevices.

It will be appreciated by one skilled in the art that the compositions of the present invention alternatively can be deployed in the abovementioned areas by setting out a trap or a dispenser containing the insecticidal composition.

The indefinite article “a” or “an” and its corresponding definite article “the” as used herein is understood to mean at least one, or one or more, unless specified otherwise.

The terms “sorb”, “sorbing”, “sorbed”, and like forms refer to the disposition of the insecticide or other ingredient(s) with respect to the nanoparticle's outer surface or interior surface and can include adsorb, adsorption, absorb, absorption, or the like dispositions or forms, and can depend upon, for example, surface area, pore size, porosity, the associative and molecular properties of the nanoparticle material(s) selected and other ingredients or optional additives selected for the formulations, and like considerations.

The Kit

Also part of the present invention is a kit where the bait composition is prepared at the site where the water-sensitive insecticide, e.g., acephate, is mixed with the bait base. The kit provides the necessary materials, containers, devices, and optionally instructions for the ultimate user to prepare the bait composition and apply it to the necessary areas, such as cracks and crevices. The kit can be included as a single package option for the end- or ultimate-user of the bait composition.

As part of the kit, a container, which is impermeable and has a cover for closing, contains the water-sensitive insecticide, for example, in pellet or powder form. The container is preferably a glass vial.

The kit can also include a closed packet where the base bait solid mixture is contained. The closed packet is preferably a re-sealable plastic bag in which the materials are thoroughly mixed, kneaded, or both, after adding the insecticide aqueous solution.

Optionally, a third part of the kit can include a dispensing container which is also closable. The container is preferably a cartridge, syringe or cylinder, which container holds the combination of the aqueous insecticide solution thoroughly mixed with the bait base material. The dispensing container can be used for allowing the mixture to set and form a gel if desired. As an example, the dispensing cartridge is then placed in a bait applicator or connected to a bait applicator for application of the composition to the cracks and crevices. The entire kit can be provided as a unitary system assembled in a packet for use at user selected site. Thus, in embodiments the present invention provides a kit for dispersing an insecticidal bait composition comprising: a) a water-sensitive insecticide in admixture with a insecticidal activity stabilizing amount of a borate compound, a nanoparticle component, or mixtures thereof; and a base bait; and b) a disperser for dispersing the insecticidal bait. The disperser can be, for example, a dispenser, a trap, applicator, or like articles or devices.

### EXAMPLES

The following examples are intended to illustrate the invention but are not to be construed as limiting. All percentages of ingredients are in weight percents unless specified otherwise.

### Example 1

Preparation of Insecticide Formula 1

The following insecticidal composition was prepared by combining the following ingredients and as indicated below.

7.0% bakers yeast extract (Universal Flavor Inc., CAS# 8013-01-2)

19.0% sucrose (United Sugar Company, CAS# 57-50-01)

9.0% ProMax 70L Soy Protein Concentrate (Central Soya, Code 4510.)

39.0% Calf's Milk Replacer (Cargill, Inc. CAS# N/A)

24.0% water

1.0% glycerol

1.0% acephate (O,S-dimethyl acetylphosphoramidothioate, Valent Corp.)

The acephate was dissolved in water, shaken in a covered container, and then added to the mixture of other ingredients identified above. The ingredients were then allowed to set.

### Example 2

Evaluation of Insecticide Formula 1 Kill Properties

The following test was carried out using the formulation of Example 1 (Formula 1) to measure acephate degradation and its effect on insecticidal activity. The 1.0% acephate formulations of Example 1 were compared for kill efficacy against cockroach adults and nymphs with the jar/smear method described hereinafter. The 4-week aging (ambient) data are reported in the following accompanying table as KT50, wherein KT50 is the time in hours required to kill 50% of the cockroach population.

TABLE 1
KT50 results of ambient aged Formula 1

| Life Stage | Fresh | 1 wk | 2 wk | 4 wk |
|---|---|---|---|---|
| Adult Males | 0.685 | 1.035 | 1.157 | 1.532 |
| Adult Females | 4.780 | 5.995 | 1.677 | 5.082 |
| Large Nymphs | 1.217 | 6.325 | 1.187 | 4.587 |
| Small Nymphs | 0.298 | 2.134 | 1.622 | 4.998 |

The biological data indicate that Formula 1 remains effective against all cockroach life stages through 4-weeks after application under ambient conditions.

The jar/smear method is described here:

Materials

1. Bait formulas for screening.

2. 16 oz. glass jars coated on the upper lip with petrolatum to prevent escape.

3. Balance for weighing the bait ingredients.

4. German cockroaches; 10 per jar.

5. Stop watch.

Method

1. Allowed 4 hours for cockroaches to acclimate with food and water in jars. Allowed alternative food and water to be present during testing period.

2. Applied 0.3 grams of bait to one lip of an inverted plastic weigh boat (simulated crack and crevice treatment).

3. Following acclimation of about 4 hours, placed the baited (and inverted) weigh boat flatly into the jar. Repeated for all cockroach jars in sequence.

4. Measured the cockroach mortality over time and determined the KT50 for each cockroach life stage.

### Example 3

Preparation of Insecticide Formula 2

The following formulation (Formula 2) was prepared with the ingredients listed in Table 2 and as described below.

1.0 wt-% acephate, 30 wt-% water, and 69 wt-% bait base of the following composition:

TABLE 2
Bait Base Composition

| Ingredients | Supplier | Wt % |
|---|---|---|
| Calf's Milk Replacer | Cargill, Inc. | 71.31 |
| CAS # N/A | Minneapolis, Minnesota 55440 | |
| 6X powdered sugar | United Sugar Company | 5.40 |
| CAS # 57-50-1 | Moorhead, Minnesota 56561 | |
| bakers yeast extract | Universal Flavor Inc. | 8.80 |
| CAS # 8013-01-2 | Indianapolis, Indiana 46241 | |
| food starch-modified | National Starch and Chemical | 0.94 |
| CAS # 113894-92-1 | Bridgewater, New Jersey 08807 | |
| sorbitol | Archer Daniels Midland | 3.70 |
| CAS # 50-70-4 | Decatur, Illinois 62526 | |
| fructose | A. E. Staley Manufacturing Co. | 6.90 |
| CAS # 57-48-7 | Decatur, Illinois 62525 | |
| sodium chloride | Cargill, Inc. | 1.25 |
| CAS # 7647-14-5 | Minneapolis, Minnesota 55440 | |
| potassium sorbate | Archer Daniels Midland | 0.38 |
| CAS # 24634-61-5 | Decatur, Illinois 62526 | |
| citric acid, anhydrous | Archer Daniels Midland | 1.32 |
| CAS # 77-92-9 | Decatur, Illinois 62526 | |
| | Total | 100% |

1. The acephate-storage (vial) was opened and 30 ml of water was added to the acephate (1.04 grams). The vial cover was closed and the vial shaken until the acephate was completely dissolved.

2. The vial contents were then added to one packet of bait base paste (described above, 68.9 grams) in a zip-lock bag. The packet was closed and thoroughly mixed by shaking and kneading.

3. The bait mixture was poured into a dispensing cartridge, covered and allowed to set for 20 minutes for the bait to gel. The resulting gel had a viscosity of about 180,000 centipoise.

### Example 4

Evaluation of Insecticide Knockdown Properties

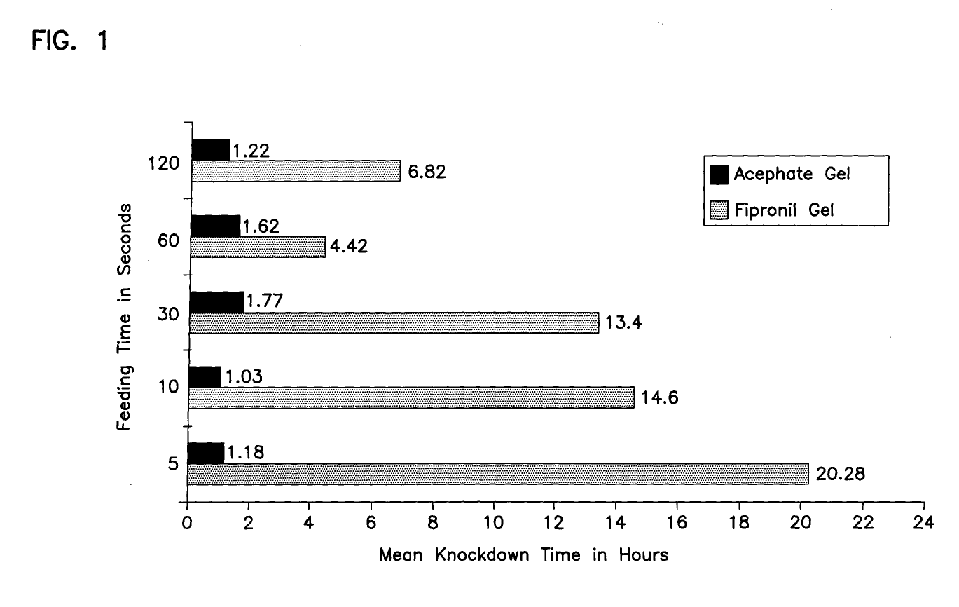

The gel composition of Example 3 (Formula 2) was compared to mean knockdown time of cockroaches as affected by the feeding time of the bait composition with a commercially available gel composition which contained fipronil as the active ingredient in a concentration of 0.01%. “Mean knockdown time” means the time it takes for 50% of a representative sample of test organisms to become moribund with time starting at the same time that the bait is given to the organisms. A commercially available fipronil gel composition was used in the same manner as the composition of the present invention and is claimed by its manufacturer to be rapid acting. The results of the tests are shown in FIG. 1. The longest mean knockdown time observed for the composition of the present invention was 1.62 hours in a 60-second feeding time. In contrast, the shortest fipronil mean knockdown time was 4.42 hours in the same feeding time, 60 seconds. Notably, in a 5-second feeding time, the gel composition of the present invention had a mean knockdown time of 1.18 hours whereas the fipronil gel took 20.28 hours for the same five second feeding time.

### Example 5

Evaluation of Insecticide Stabilization by Boric Acid

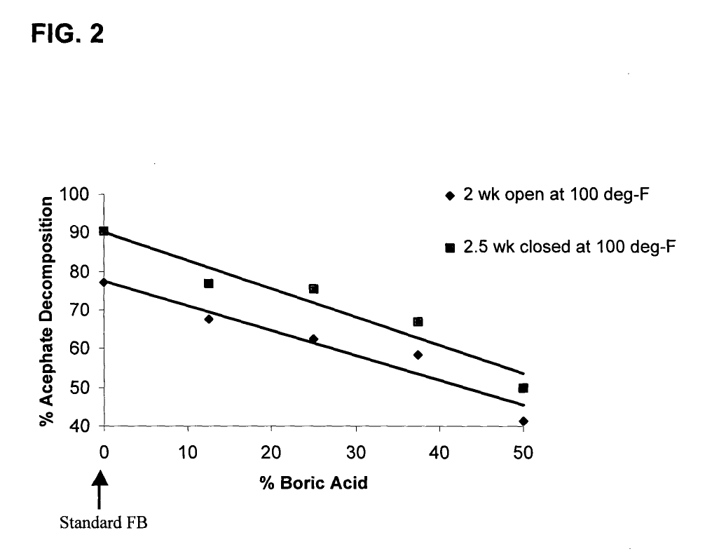

A study was conducted where boric acid was added to a standard composition to determine the effect of the addition on acephate stability. The standard composition was prepared by combining a solution of 1 gram acephate in 30 grams water with 69 grams of base bait food matrix to yield a final bait with 1% acephate and 69% food matrix, as described in Example 3. Related samples with boric acid were prepared by substituting boric acid for an equivalent % of the food matrix while keeping the concentration of acephate and water constant. Bait applications were made of each composition and stored in an oven at 100° F. (37.5° C.) for two weeks. Sealed syringes of each composition were stored in an oven at 100° F. (37.5° C.) for 2.5 weeks. After elevated temperature aging, the samples were evaluated by the LC/MS method (described in Example 7) to determine the extent of acephate degradation. The data is illustrated in FIG. 2. In FIG. 2, Standard FB (fast bait) refers to the comparative formulas without boric acid present.

The data show that in the standard composition with 0% boric acid, the acephate is significantly less stable than compositions where boric acid has been added. Additionally, the results show that acephate stability is improved for both the packaged bait and bait applications.

### Example 6

Preparation of Insecticide Formula 3

A paste bait was prepared according to the formula (Formula 3) of ingredients listed in Table 3 below. Acephate and potassium sorbate were dissolved in water. Glycerin and sweetened condensed milk were then stirred into the aqueous solution of acephate and sorbate. In a separate mixing vessel the non-liquid components, boric acid, maltodextrin, and xanthan gum were combined and mixed. The mixture of dry ingredients was then added with continuous mixing to the aqueous solution at such a rate to maintain a homogenous paste. The resultant homogenous paste was evaluated for stability relative to the control composition of Example 3, which did not contain boric acid.

TABLE 3
Formula 3.

| Ingredient | % in Formula |
|---|---|
| Technical Boric Acid | 44.5 |
| Sweetened Condensed Milk | 34.3 |
| City Water | 17.9 |
| Xanthan Gum, Keltrol F | 0.1 |
| Maltodextrin, Maltrin M100 | 0.3 |
| Glycerin | 1.8 |
| Potassium Sorbate Granular | 0.1 |
| Acephate | 1.0 |
| Total | 100.0 |

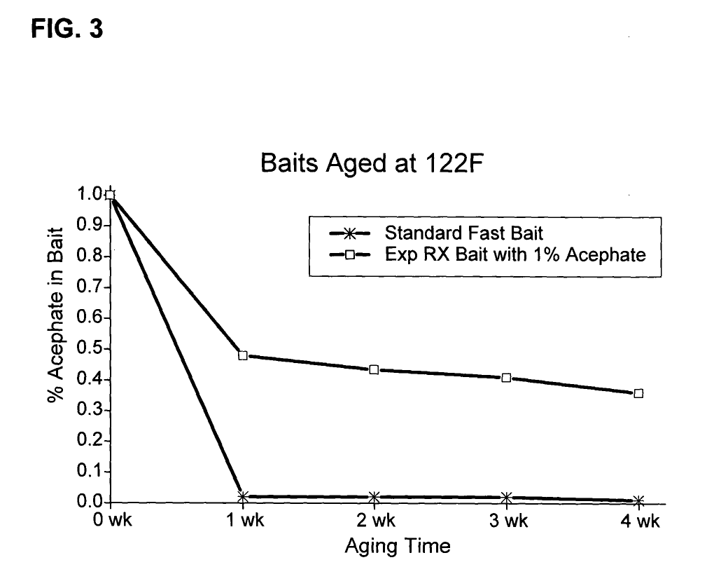

About 10 grams of each compositions were placed in separate vials stored in ovens at 122 and 100 degrees F. for 1-4 weeks. The stability data as a percentage of acephate present or remaining in the fresh and thermally aged bait samples composed of this formula (Exp RX with 1% acephate) relative to the standard fast bait composition without boric acid is shown in FIG. 3.

### Example 7

Method for Determining Acephate Insecticide in Bait Formulations.

This method quantifies the amount of acephate in cockroach bait formulations.

Sample Preparation

Samples for analysis were generally treated as 0.5-0.8 gram placements of the formulated bait compositions in glass screw cap vials (30 mL). Methanol (20 or 25 mL) was added to the sample vials and allowed to soak into the cockroach bait for 5 min to 2 hours depending on the consistency of the bait. Some samples require the use of a spatula to break up chunks of the bait. Difficult samples were placed in a sonication bath for 10 min. Once a fluffy slurry of bait matrix in methanol was obtained, the solid was allowed to settle and 1 mL of each sample was diluted by 50 or 100 in water, depending on the expected concentration of acephate. The diluted samples were filtered if necessary and analyzed by LC/MS as described below.

LC/MS Analysis

Samples were subjected to reverse phase liquid chromatography on a StableBond (Agilent Technologies) C18 cartridge column (4.5 mm×30 mm) with gradient elution consisting of 98% 4 mM ammonium acetate and 2% methanol to 95% methanol. A portion of the 1 mL/min LC flow was diverted to the mass spectrometer which was operated using electrospray positive ionization. The instrument was operated in MS² mode and the m/z 143 daughter of the m/z 184 parent ion (acephate+H⁺) was selected for quantification.

The instrument was calibrated with standard solutions of acephate in water prepared fresh prior to each analysis. The method was linear from approximately 0.1 ppm to 2.5 ppm. However, the best results were generally obtained using six point quadratic calibration curves generated from standard solutions ranging from 0.1 ppm to 5 ppm. The calibration fit coefficients of determination (R2) using a quadratic equation were consistently >0.9999.

### Example 8

Preparation of Nanoparticle Containing Insecticidal Compositions

Insecticidal baits containing, for example, nanoparticle component stabilized acephate-water mixtures, were prepared by first forming a solution of acephate in water; second, mixing the acephate-water solution with the nanoparticle component to form a treated nanoparticle component; optionally drying the resulting treated nanoparticle component to remove excess water, or if desired, to from a pourable solid or powder; and finally combining the treated nanoparticle component with the bait base. Representative insecticidal bait formulations and the amount of ingredients used in each are shown in Table 4 below, including a comparative control, Bait 8.6, which was prepared by mixing the listed ingredients without a nanoparticle component present. Baits were formulated to contain about 1,000 acephate molecules per nanoparticle. Bait formulations, totaling 10 grams each, were prepared using the ingredients indicated in the table and a different nanoparticle component was used for each bait as indicated in the table footnotes. The bait base used in each sample was the same as used in Formula 2. City tap water and acephate, technical grade O,S-dimethyl acetylphosphoramidothioate from Valent Corp., were used without purification to prepare the samples.

TABLE 4
Insecticidal Bait Formulations Including Nanoparticle Component

| Bait | Nanoparticle (g)^{a} | Acephate (g) | Water (g) | Bait - Base (g) |
|---|---|---|---|---|
| 8.1 | 1.00 | 0.10 | 5.9 | 3.0 |
| 8.2 | 3.30 | 0.10 | 5.9 | 3.0 |
| 8.3 | 3.30 | 0.10 | 3.6 | 3.0 |
| 8.4 | 1.00 | 0.10 | 3.6 | 3.0 |
| 8.5 | 1.00 | 0.10 | 5.9 | 3.0 |
| 8.6 | None | 0.10 | 6.9 | 3.0 |

^{a}Nanoparticle information in the corresponding baits:
8.1. TiO₂ (Titanium oxide); Ti-Pure ® R706; Du Pont; average particle size about 360 nm.
8.2. MgO (Magnesium Oxide); Ultra-Tek MgO; Nanoscale Materials, Inc.; average particle size 7-9 nm.
8.3. Al₂O₃ (Aluminum oxide); UPW630; DeGussa AG; average particle size about 13 nm.
8.4. SiO₂ (Amorphous silica); Klebosol 30N12; Clariant Corporation; average particle size about 12 nm.
8.5. SiO₂ (Amorphous silica); Snowtex-ST-OL, Nissan Chemical; average particle size about 40-50 nm.
8.6. Control-no nanoparticle component.

### Example 9

Efficacy Evaluation of Insecticidal Compositions Containing a Nanoparticle Component

The following tests were carried out using the formulations of Example 8 to indirectly measure acephate degradation and formulation degradation generally based upon “total percent kill” results, “KT50” results, and qualitative appearance aesthetics. Each bait formulation was tested for standard efficacy using a standard procedure for fresh, 3-day closed aged at 122° F., and 7-day closed aged at 122° F. Two jars of male cockroaches were used for each test. Each jar was checked at four hours, twenty-four hours, and forty-eight hours for cockroach mortality. Examination of the bait samples (8.1-8.6) after three days of oven aging at 120° F. (photograph not shown) showed discoloration and possible degradation or decomposition of bait samples 8.2-8.6. However, bait sample 8.1 (TiO₂) was noticeably free of discoloration and retained its original bright-white appearance. The aging result suggests that the TiO₂ nanoparticle component may provide formulation stabilization and can provide appearance advantages. The biological efficacy data is shown in Table 5 below. Bait sample 8.1 exhibited superior kill properties for fresh as well as aged baits compared to the other test baits or the control bait, 8.6. Taken together, these results suggest that certain nanoparticle components, such as TiO₂, can provide material dependent stabilization to the bait, such as insecticidal potency and insecticidal attractancy. Further, the nanoparticle containing bait formulations advantageously exhibited no apparent anti-feedant properties (i.e. repellant properties).

TABLE 5
Efficacy Evaluation of Fresh, 3-Day, and 7-Day Aged Baits.
KT50 (hr)^{b} and Total % Kill^{c}

| | | | |
|---|---|---|---|
| Bait^{a} | Fresh | 3-Day | 7-Day |

| | | | | | | |
|---|---|---|---|---|---|---|
| 8.1 | 4 | 100 | 4 | 100 | n/a | 10 |
| 8.2 | 4 | 90 | n/a | 0 | n/a | 0 |
| 8.3 | 4 | 90 | 24 | 70 | n/a | 0 |
| 8.4 | 4 | 90 | n/a | 40 | n/a | 0 |
| 8.5 | 4 | 90 | n/a | 40 | n/a | 0 |
| 8.6 | 4 | 90 | 4 | 90 | n/a | 0 |

^{a}See footnotes in Table 4 of Example 8.
^{b}KT50 (hr) is the time in hours to kill 50% of the cockroaches within the sample.
^{c}Total % Kill is the total percent of cockroaches dead within 24 hours upon exposure to the bait sample.

The above specification, examples and data provide a complete description of the manufacture and use of the composition of the invention. All patents and publications disclosed herein are incorporated by reference in their entirety. Since many embodiments of the invention can be made without departing from the spirit and scope of the invention, the invention resides in the claims hereinafter appended.

We claim:

1. An insecticidal bait composition comprising:
(a) an insecticidal effective amount of a water-sensitive insecticide;
(b) an effective amount of an insecticide stabilizer; and
(c) a base bait containing water, and at least one of a feeding stimulant and an attractant.

2. The composition of claim 1 wherein insecticidal effective amount is characterized by the insecticidal bait composition having an insecticidal potency KT50 of less than about 24 hours after exposure.

3. The composition of claim 1 wherein an effective amount of an insecticide stabilizer is from about 5 to about 60 wt-% of the total weight of the insecticidal bait composition.

4. The composition of claim 1 wherein the base bait has an insect attractancy characterized by a base bait which retains insect attractancy while the composition retains insecticidal effectiveness.

5. The composition of claim 1 wherein the insecticide stabilizer lengthens the insecticidal effectiveness of the water-sensitive insecticide by at least about 10 percent compared to the insecticidal bait composition free of the insecticide stabilizer.

6. The composition of claim 5 wherein the insecticide is acephate and the stabilizer is boric acid.

7. The composition of claim 5 wherein the insecticide is acephate.

8. The composition of claim 5 wherein the stabilizer is boric acid.

9. The composition of claim 1 wherein insecticidal effectiveness of the insecticide is lengthened by from about 10 to about 100 percent compared to an insecticidal bait composition free of the insecticide stabilizer.

10. The composition of claim 9 wherein the insecticide comprises acephate.

11. The composition of claim 9 wherein the stabilizer comprises boric acid.

12. The composition of claim 1 wherein insecticidal effectiveness of the insecticide is lengthened by from about 10 to about 50 percent compared to an insecticidal bait composition free of the insecticide stabilizer.

13. The composition of claim 12 wherein the insecticide comprises acephate.

14. The composition of claim 12 wherein the stabilizer comprises boric acid.

15. The composition of claim 1 wherein the insecticidal effective amount of a water-sensitive insecticide comprises from about 0.1 to about 5 wt-% acephate; the effective amount of an insecticide stabilizer comprises from about 5 to about 60 wt-% boric acid; and the base bait comprises from about 3 to about 40 wt-% water.

16. The composition of claim 1 wherein the feeding stimulant, the attractant, or mixtures thereof, comprise a protein, a carbohydrate, a fat, or mixtures thereof.

17. The composition of claim 1 wherein the bait base further comprises a calf's milk replacer, sucrose, bakers yeast extract, starch, sorbitol, fructose, sodium chloride, potassium sorbate, citric acid, or mixtures thereof

18. The composition of claim 1 wherein the bait base further comprises a gelling agent.

19. The composition of claim 18 wherein the gelling agent comprises about 0.1 to about 5 wt-% of the bait base.

20. The composition of claim 1 wherein the insecticide is acephate.

21. The composition of claim 1 wherein the insecticide stabilizer is boric acid.

22. The composition of claim 1 wherein the insecticide stabilizer is a nanoparticle component.

23. The composition of claim 1 wherein the insecticide stabilizer comprises a nanoparticle component in an amount of from about 0.1 to about 50 wt-%.

24. The composition of claim 1 wherein the insecticide stabilizer comprises a boric acid compound, a nanoparticle component, or a mixture thereof, in an amount of from about 0.1 to about 50 wt-%.

25. An insecticidal bait composition comprising:
(a) about 0.10 to about 2 wt-% acephate insecticide;
(b) about 5 to about 50 wt-% boric acid insecticide stabilizer;
(c) about 10 to about 30 wt-% water; and
(d) the balance being a bait base.

26. The composition of claim 25 wherein the bait base comprises a feeding stimulant, an attractant, or mixtures thereof.

27. The composition of claim 26 wherein the feeding stimulant, the attractant, or mixtures thereof comprise a protein, a carbohydrate, a fat, or mixtures thereof.

28. The composition of claim 25 wherein the bait base further comprises a gelling agent in an amount of from about 0.1 to about 5 wt-% of the bait base.

29. The composition of claim 25 wherein the acephate is in an amount of from about 1 to about 2 wt-% and the boric acid insecticide stabilizer is in an amount of from about 15 to about 20 wt-% of the bait composition.

30. The composition of claim 25 further comprising a nanoparticle component in an amount of from about 0.1 to about 50 wt-% of the total weight of the composition.

31. A method of prolonging the insecticidal activity of a water soluble, water degradable insecticide in a bait composition containing the insecticide, comprising combining the bait composition with from about 5 to about 60 wt-% based on the total weight of the combined composition of an effective amount of an insecticide stabilizer.

32. The method of claim 31 further comprising mixing the water degradable insecticide with the insecticide stabilizer prior to combining with the other bait components.

33. The method of claim 31 wherein the insecticide comprises acephate.

34. The method of claim 31 wherein the insecticide stabilizer comprises a borate compound.

35. The method of claim 31 wherein the insecticide stabilizer comprises a nanoparticle component.

36. A method of controlling insect pests comprising applying to areas to be controlled the composition of claim 1.

37. The method of claim 36 wherein the insect pests are cockroaches.

38. The method of claim 36 wherein the insecticide is acephate.

39. A method of controlling insect pests comprising applying to areas to be controlled a composition of claim 25.

40. The method of claim 39 wherein the insect pests are cockroaches.

41. An insecticidal composition comprising:
(a) an effective insecticidal amount of a water-sensitive insecticide;
(b) an effective amount of water to dissolve at least a part of the water-sensitive insecticide, wherein at least a portion of the water-sensitive insecticide is dissolved in the water;
(c) an effective amount of a water-sensitive insecticide stabilizer, wherein the stabilizer is a borate compound, a nanoparticle component, or mixtures thereof; and
(d) an effective amount of a bait base comprising an attractant, a feeding stimulant, or mixtures thereof.

42. The composition of claim 41 wherein the borate compound is boric acid, a borate salt, or mixtures thereof.

43. The composition of claim 41 wherein the nanoparticle component comprises metal hydroxide nanoparticles, metal oxide nanoparticles, or mixtures thereof.

44. The composition of claim 43 wherein the metal is selected from the group consisting of Mg, Ca, Si, Ti, Zr, Fe, V, Mn, Ni, Cu, Al, Zn, and mixtures thereof.

45. The composition of claim 44 wherein the nanoparticle component comprises titanium dioxide.

46. An insecticidal bait composition prepared by the process comprising:
combining
(a) an insecticidal effective amount of a water-sensitive insecticide;
(b) an effective amount of an insecticide stabilizer; and
(c) a base bait containing water, and at least one of a feeding stimulant and an attractant.

47. A process for preparing a ready-to-use insecticidal bait composition comprising:
(a) dissolving a water sensitive insecticide in a specified amount of water;
(b) combining the resulting mixture of insecticide and water with an effective amount of an insecticide stabilizer;
(c) combining the resulting mixture with a bait base comprising a feeding stimulant, an attractrant, or both, and optionally containing one or more gelling agent(s);
(d) optionally agitating the resulting combination; and
(e) optionally allowing the mixed combination to form a gel or paste.

48. A process for stabilizing a water-sensitive insecticide contained in an insecticidal bait composition comprising:
(a) dissolving a water-sensitive insecticide in a specified amount of water;
(b) mixing an effective amount of an insecticide stabilizer with a bait base containing at least one of a feeding stimulant and an attractrant;
(c) combining the resulting insecticide-water mixture with the resulting stabilizer-bait base mixture; and
(d) optionally agitating the resulting combination.

49. A kit for dispersing an insecticidal bait composition comprising:
a) a water-sensitive insecticide in admixture with a insecticidal activity stabilizing amount of a borate compound, a nanoparticle component, or mixtures thereof; and a base bait; and
b) a disperser for dispersing the insecticidal bait.

50. The kit of claim 49 wherein the disperser comprises a dispenser, a trap, or applicator.

51. A kit for application of an insecticidal bait composition comprising.
a) a water-sensitive insecticide in admixture with a insecticidal activity stabilizing amount of a borate compound, a nanoparticle component, or mixtures thereof; and
b) a base bait.

52. The kit of claim 51 further comprising a disperser for dispersing the insecticidal bait composition.
